(19) United States
(12) Patent Application Publication
(10) Pub. No.: US 2025/0017712 A1
(43) Pub. Date: Jan. 16, 2025

(54) POWERED TOOTHBRUSH AND BRUSH HEAD ASSEMBLIES THEREFOR

(71) Applicant: Church & Dwight Co., Inc., Princeton, NJ (US)

(72) Inventors: Robert W. Fusi, II, Flemington, NJ (US); Jason B. Wilds, Yardley, PA (US); Christopher B. King, Philadelphia, PA (US); Paul D. Carse, Milford, NJ (US); Kelly Gail Duncan, Bethlehem, PA (US); William H. Carr, Phillipsburg, NJ (US)

(21) Appl. No.: 18/769,020

(22) Filed: Jul. 10, 2024

Related U.S. Application Data
(60) Provisional application No. 63/526,090, filed on Jul. 11, 2023.

(51) Int. Cl. A61C 17/34; A46B 5/00; A46B 13/00; A46B 13/02

(52) U.S. Cl. CPC A61C 17/349; A46B 5/0095; A46B 13/008; A46B 13/02; A61C 17/3436; A61C 17/3445

(57) ABSTRACT

An embodiment of a brush head assembly for a powered toothbrush includes a housing, a first brush head supported by the housing, and a second brush head supported by the housing. In addition, the brush head assembly includes a driveshaft positioned in the housing and coupled to the first brush head and the second brush head, the driveshaft having a longitudinal axis. A rotation of the driveshaft about a longitudinal axis is configured to pivot the first brush head and translate the second brush head relative to the housing.

### CROSS-REFERENCE TO RELATED APPLICATIONS

This application claims priority to and the benefit of U.S. provisional patent application No. 63/526,090, filed Jul. 11, 2023 and entitled “Powered Toothbrush and Brush Head Assemblies Therefor,” the entire contents of which are incorporated herein by reference.

### BACKGROUND

Powered toothbrushes have gained substantial popularity and are used to more effectively and efficiently clean one's teeth as compared to a traditional, manual powered toothbrush. A powered toothbrush may include a powered brush head that engages with the teeth to thereby remove plaque, food particles, or other buildup. A driver, such as an electric motor, may be used to drive the brush head during operations.

### BRIEF SUMMARY

Some embodiments disclosed herein are directed to a brush head assembly for a powered toothbrush. In some embodiments, the brush head assembly includes a housing, a first brush head supported by the housing, and a second brush head supported by the housing. In addition, the brush head assembly includes a driveshaft positioned in the housing and coupled to the first brush head and the second brush head, the driveshaft having a longitudinal axis. A rotation of the driveshaft about a longitudinal axis is configured to pivot the first brush head and translate the second brush head relative to the housing.

Some embodiments disclosed herein are directed to a powered toothbrush. In some embodiments, the powered toothbrush includes a handle including a driver and a female connector coupled to the driver, wherein the female connector includes a recess. In addition, the powered toothbrush includes a brush head assembly coupled to the handle. The brush head assembly includes a housing, one or more brush heads supported on the housing, and a driveshaft positioned in the housing, the driveshaft including a longitudinal axis and a male connector. The male connector is inserted within the recess of the female connector such that the driver is configured to rotate the driveshaft about the longitudinal axis via the male connector and the female connector to actuate the one or more brush heads relative to the housing.

Some embodiments disclosed herein are directed to a brush head assembly for a powered toothbrush. In some embodiments, the brush head assembly includes a housing, a first brush head supported by the housing, and a second brush head supported by the housing. In addition, the brush head assembly includes a transmission assembly positioned within the housing. The transmission assembly includes a driveshaft having a longitudinal axis. In addition, the transmission assembly includes a first cam assembly configured to convert a rotation of the driveshaft about the longitudinal axis into a pivot of the first brush head about an axis of rotation that is different from the longitudinal axis. Further, the transmission assembly includes a second cam assembly configured to convert the rotation of the driveshaft about the longitudinal axis into an axial translation of the second brush head along the longitudinal axis.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those having ordinary skill in the art upon reading the following detailed description, and by referring to the accompanying drawings. It should be appreciated that this disclosure may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of various embodiments, reference will now be made to the accompanying drawings in which:

FIG. 1 is a perspective view of a powered toothbrush according to some embodiments;

FIG. 2 is a perspective view of a handle of the powered toothbrush of FIG. 1 according to some embodiments;

FIG. 3 is a perspective view of a brush head assembly of the powered toothbrush of FIG. 1 according to some embodiments;

FIG. 4 is a perspective view of a transmission assembly installed within the brush head assembly of FIG. 3 according to some embodiments;

FIG. 5 is a segmented prospective view of a driveshaft of the transmission assembly of FIG. 4 according to some embodiments;

FIG. 6 is a side, cross-sectional view of a connection between the brush head assembly and the handle of the powered toothbrush of FIG. 1 according to some embodiments;

FIG. 7 is a cross-sectional view of the engaged connectors shown in the connection of FIG. 6, taken along section A-A in FIG. 6 according to some embodiments;

FIG. 8 is an exploded, perspective view of the transmission assembly of the brush head assembly of FIG. 3 according to some embodiments;

FIGS. 9A-9D are sequential rear views of the brush head assembly of FIG. 3, showing the movements of the brush heads and transmission assembly during a revolution of the driveshaft according to some embodiments;

FIG. 10 is a side partial cross-sectional view of a brush head assembly that may be used within the powered toothbrush of FIG. 1 according to some embodiments;

FIG. 11 is a perspective view of a transmission assembly installed within the brush head assembly of FIG. 10 according to some embodiments;

FIG. 12 is a perspective view of a brush head for use within the brush head assembly of FIG. 10 according to some embodiments;

FIG. 13 is a top view of the brush head of FIG. 12 according to some embodiments;

FIG. 14 is a perspective view of a collar of the brush head of FIG. 12 and a body of a cam assembly of the transmission assembly of FIG. 11 according to some embodiments;

FIG. 15 is a side view of an alternative embodiment of the complimentary cam surfaces of the collar and the cam assembly of FIG. 14 according to some embodiments;

FIG. 16 is a perspective view of a transmission assembly of a brush head assembly for use with the powered toothbrush of FIG. 1 according to some embodiments;

FIG. 17 is a perspective, partial cross-sectional view of the transmission assembly and brush head assembly of FIG. 16 according to some embodiments;

FIGS. 18 and 19 are perspective views of a transmission assembly of a brush head assembly for use with the powered toothbrush of FIG. 1 according to some embodiments; and

FIG. 20 is a perspective view of a transmission assembly of a brush head assembly for use with the powered toothbrush of FIG. 1 according to some embodiments.

### DETAILED DESCRIPTION

As previously described, a powered toothbrush may include a driver (e.g., an electric motor) that powers the movement of a brush head to clean a user's teeth. A transmission assembly may be included within the powered toothbrush to convert the output of the electric motor into the desired movements of the brush head during operations. A common complaint among users of powered toothbrushes is the excess noise and vibrations that are generated by the driver and/or transmission during teeth brushing. In addition, some powered toothbrushes may include multiple brush heads that have different movement patterns for more effective teeth cleaning. In such a case, the transmissions for converting the output of the driver into the multiple movements of the brush heads may be complex, and further contribute to additional noise and/or vibration generation during operations. For instance, to facilitate a translational movement (as opposed to a pivoting movement) of a brush head, a linear actuator-type driver may be utilized that reciprocates an output shaft along a longitudinal axis thereof. However, such drivers may result in additional noise and vibrations for the user during operations.

Accordingly, embodiments disclosed herein include powered toothbrushes and brush head assemblies for powered toothbrushes that include direct drive transmission assemblies for driving movement (e.g., such as oscillatory and/or reciprocal movement) of multiple brush heads on the brush head assembly during operation. In some embodiments, the transmission assemblies described herein may convert a rotational movement of a driver (such as an electric motor) into both a pivoting movement of a first brush head and a translating movement of a second brush head. As will be described in more detail below, by using a relatively smoother rotational output from a driver to drive both the pivoting and translating movements of the brush heads, the amount of excess noise and vibrations sensed by the user may be reduced. In addition, as described herein, other aspects may also be incorporated into embodiments of the powered toothbrushes and brush head assemblies therefor to further reduce noise and improve overall performance of the brush head assemblies and associated powered toothbrush.

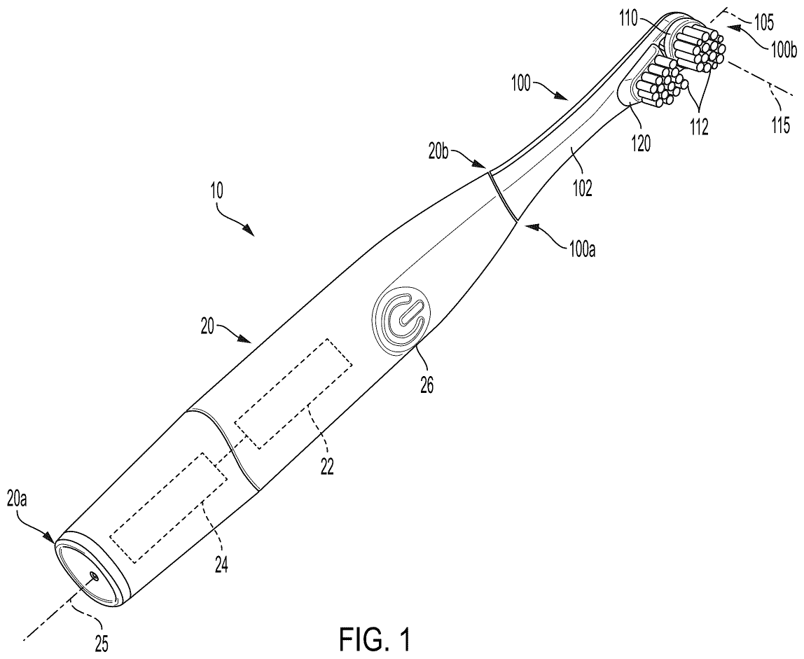

FIG. 1 shows a powered toothbrush 10 according to some embodiments disclosed herein. The powered toothbrush 10 (or more simply “toothbrush 10”) may be an electrically powered toothbrush; however, other power sources are contemplated for other embodiments (e.g., pneumatic power). In general, the toothbrush 10 includes a handle (or base) 20 and a brush head assembly 100 (or more simply “head assembly 100”) removably coupled to the handle 20. The head assembly 100 may be a replaceable portion of the toothbrush 10 so that a user may eventually decouple the head assembly 100 from the handle 20 and replace it with a new head assembly 100.

The handle 20 includes a central or longitudinal axis 25, a first or lower end 20a, and a second or upper end 20b that is spaced from the lower end 20a along the longitudinal axis 25. As schematically shown in FIG. 1, a driver 22 may be positioned within the handle 20 that is configured to drive the motion of one or more brush heads (e.g., brush heads 110, 120 described in more detail below) on the head assembly 100 during operations. As previously described, the toothbrush 10 may be an electrically powered toothbrush. As a result, the driver 22 may be an electric motor. In addition, the toothbrush 10 may include an onboard power source 24, such as a battery (e.g., a rechargeable battery, non-rechargeable battery, etc.), that is electrically coupled to the driver 22. A power switch 26 may be defined on the handle 20 that may be manipulated or engaged by a user to start or stop operation of the driver 22 during operations.

With continuing reference to FIG. 1, the head assembly 100 includes a central or longitudinal axis 105, a first or lower end (or proximal end) 100a, and a second or outer end (or distal end) 100b that is spaced from the lower end 100a along the longitudinal axis 105. As shown in FIG. 1, head assembly 100 may be coupled to the handle 20 such that the longitudinal axes 25, 105 are coaxially aligned with one another. In particular, the lower end 100a of the head assembly 100 may be engaged with the upper end 20b of the handle 20 so that the head assembly 100 is projected or extended outward from the upper end 20a of the handle 20 along the aligned axes 25, 105.

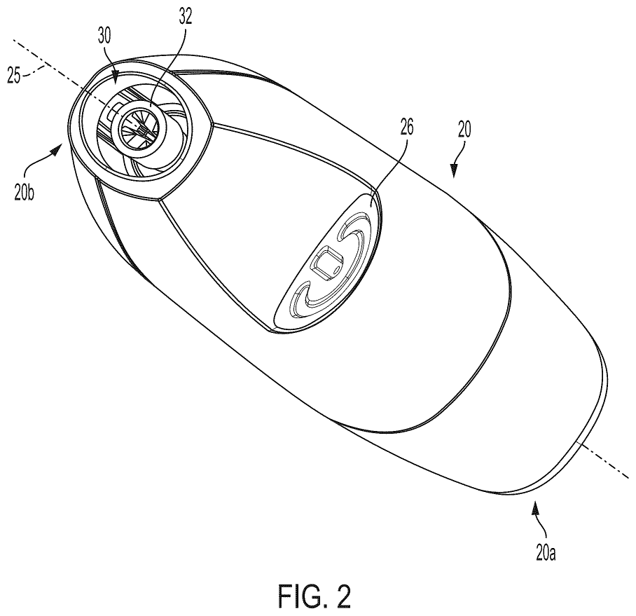

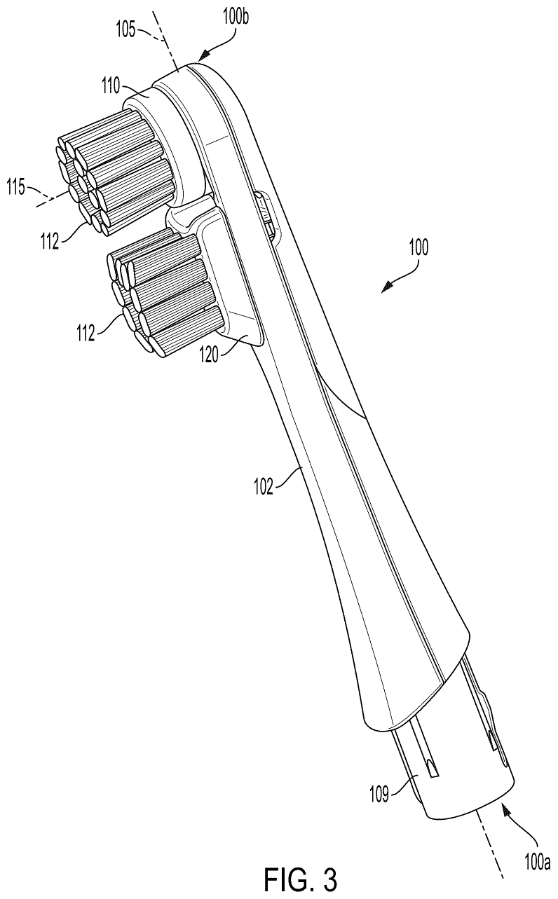

In particular, as shown in FIG. 2, the handle 20 may include a receptacle 30 that is defined on or at the upper end 20a. A connector 32 may be positioned within the receptacle 30 that is coupled to the driver 22 (FIG. 1). During operations, the driver 22 (FIG. 1) may rotate the connector 32 about the longitudinal axis 25. As shown in FIG. 3, the head assembly 100 may include a projection or plug 109 defined on or at the lower end 100a. As may be appreciated by FIGS. 1-3, during operations, the projection 109 may be received within the receptacle 30 so as to couple the lower end 100a of the head assembly 100 to the upper end 20b of the handle 20 and thereby align the axes 25, 105 and assemble the toothbrush 10 as shown in FIG. 1. Further details of the connection between the lower end 100a of head assembly 100 and upper end 20b of handle 20 are provided below according to some embodiments.

With reference to FIGS. 1 and 3, the head assembly 100 may include a plurality of brush heads 110, 120 that are supported on a housing 102 of the head assembly 100. The brush heads 110, 120 may be used to clean a user's teeth during operations with the toothbrush 10. Specifically, in some embodiments, the head assembly 100 includes a first brush head 110 and a second brush head 120. Each of the brush heads 110, 120 includes a plurality of bristles 112 that are configured to engage with a user's teeth.

The first brush head 110 and the second brush head 120 may have different movement types or patterns in order to move the bristles 112 across a user's teeth in different directions for more effective cleaning. In particular, the first brush head 110 may be pivoted or oscillated about an axis of rotation 115 that is orthogonal (or perpendicular) to the longitudinal axis 105 (and thus also orthogonal to a projection of the longitudinal axis 25) of the head assembly 100, and the second brush head 120 may be reciprocally translated relative to the head assembly 100 in an axial direction with respect to the longitudinal axis 105. Both of these movements or motions of the brush heads 110, 120 may be driven by the driver 22 during operations via a transmission assembly (not shown) that is positioned at least partially positioned within the head assembly 100. Further details of embodiments of the transmission assembly (not shown in FIG. 1) for driving the movement of the brush heads 110, 120 are described below.

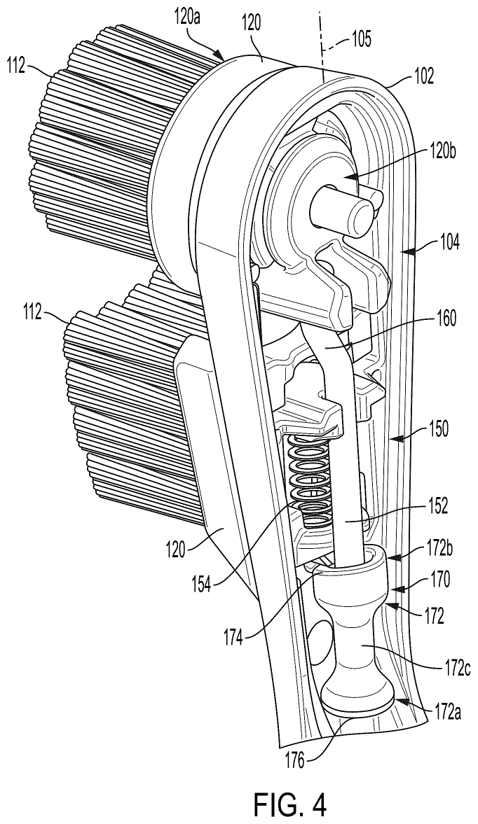

Reference is now made to FIG. 4, which shows a transmission assembly 150 of the head assembly 100 according to some embodiments. As previously described, the transmission assembly 150 may be configured to convert an output rotation of the driver 22 (FIG. 1) into the respective pivotal and translational motion of the first brush head 110 and second brush head 120. The housing 102 of head assembly 100 may define an inner chamber 104, and the transmission assembly 150 is positioned within the chamber 104. FIG. 4 shows the head assembly 100 with a panel or portion of the housing 102 removed so as to expose the inner chamber 104 and transmission assembly 150 therein.

The transmission assembly 150 includes a driveshaft 152 (or more simply “shaft 152”) that may be coupled to the driver 22 positioned in the handle 20 (FIG. 1). The transmission assembly 150 further includes a first cam assembly 160 and a second cam assembly 170 coupled to the shaft 152. The transmission assembly 150 is configured to actuate both the first brush head 110 and the second brush head 120 relative to the housing 102 when the shaft 152 rotates about the longitudinal axis 155. Specifically, as will be described in more detail below, the first cam assembly 160 and the second cam assembly 170 are configured to convert (at least partially) a rotational motion of the shaft 152 into the pivotal and translational movements of the first brush head 110 and second brush head 120, respectively, during operations.

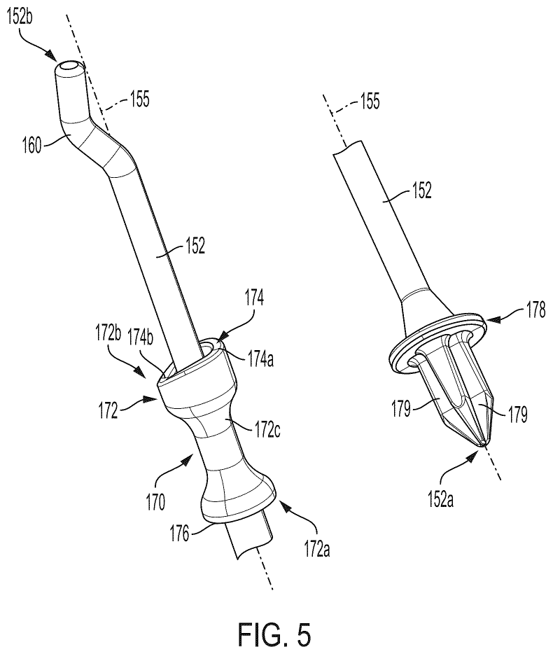

More particularly, reference is now made to FIG. 5, which shows the shaft 152 of the transmission assembly 150 (FIGS. 4 and 5). The shaft 152 includes a longitudinal axis 155, a first or lower end portion 152a, and a second or upper end portion 152b that is spaced from the lower end portion 152a along the longitudinal axis 155. The longitudinal axis 155 may be coaxially aligned with (or parallel to) to the longitudinal axis 105 of head assembly 100 when the shaft 152 is installed within the chamber 104 as shown in FIG. 4. The first cam assembly 160 may be defined, included on, or coupled to the shaft 152 at or proximate to the upper end portion 152b, and the second cam assembly 170 may be defined, included on, or coupled to the shaft 152 axially between the first cam assembly 160 and the lower end 152a. A connector 178 may be positioned at or proximate to the lower end portion 152a. The connector 178 is described in more detail below; however, generally speaking, the connector 178 may comprise a male connector member that includes one or more (e.g., a plurality of) facets 179 that comprise one or more axially extending planar surfaces that are to engage with corresponding facets (e.g., facets 33) defined in the connector 32 positioned in the receptacle 30 at the upper end 20a of handle 20 (FIG. 2) during operations.

The first cam assembly 160 may comprise a radial deviation or bend of the shaft 152 relative to the longitudinal axis 155, at or proximate to the upper end portion 152b. In particular, the bend defining the first cam assembly 160 may extend radially away or outward from the longitudinal axis 155 such that the first cam assembly 160 defines or forms a radial eccentricity about the shaft 152. In some embodiments, the first cam assembly 160 may alternatively comprise a radial projection member (e.g., such as a separate member that is coupled to the shaft 152) that extends radially outward from the central axis 155. During operations, the first cam assembly 160 may sweep in a circumferential arc about the axis 155 as the shaft 152 is rotated about axis 155 during operations.

The second cam assembly 170 comprises an annular body 172 that is connected to or is integrated with the shaft 152. For instance, in some embodiments, the body 172 may be separate piece or member that is coupled to shaft 152 (e.g., via direct molding of the body 172 onto and about the shaft 152, mechanically coupling the body 172 to the shaft 152, etc.). In some embodiments, the shaft 152 and the body 172 may comprise a monolithic, single-piece body such that the body 172 is integrally formed with the shaft 152. In either case, the body 172 may be positioned on shaft 152, axially between the first cam assembly 160 and the lower end 152a (and thus connector 178).

The body 172 may include a first or lower end 172a, a second or upper end 172b that is spaced from the lower end 172a along the longitudinal axis 155. Because the ends 172a, 172b are separated along the longitudinal axis 155, the ends 172a, 172b may be referred to herein as axial ends. In addition, the body 172 may include a radially outer surface 172c that extends between the upper ed 172b and the lower end 172a. The upper end 172b may include or define a cam surface 174 that is configured to engage with the second brush head 120 (FIG. 4) so as to axially translate the second brush head 120 as previously described, as the shaft 152 is rotated about the longitudinal axis 155.

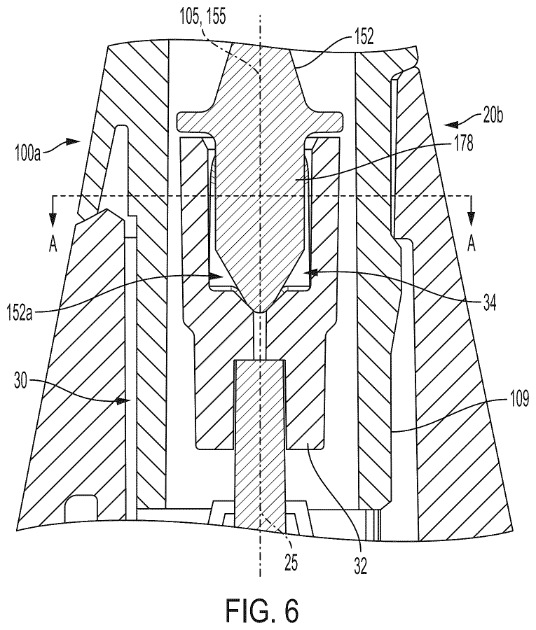

The cam surface 174 may extend annularly or circumferentially about the longitudinal axis 155, and thus may be referred to as an “annular cam surface.” The cam surface 174 may include a first portion 174a and a second portion 174 that are circumferentially spaced from one another about the longitudinal axis 155. The first portion 174a may be positioned axially closer to the upper end 152a (and thus also the upper end 100a of head assembly 100) than the second portion 174b. In addition, in some embodiments, the cam surface 174 may include a continuous, smooth curvature between the first portion 174a and the second portion 174b. For instance, in the embodiment illustrated in FIG. 5, the cam surface 174 may have a helical curvature connecting the first portion 174a and the second portion 174b. Specifically, the cam surface 174 may comprise a pair of helicoidal surfaces that extend helically in opposite helical directions between the first portion 174a and the second portion 174 on radially opposite sides of the longitudinal axis 155. However, other curvatures and shapes are contemplated for the cam surface 174 in other embodiments as will be described in more detail below. Thus, the use of the helicoidal surfaces on the cam surface 174 shown in FIG. 6 should not be interpreted as limiting other potential shapes or curvatures of the cam surface 174 according to other embodiments.

As shown in FIGS. 4 and 5, the radially outer surface may include one or more contours (e.g., projections, recesses) that may facilitate retention of the second cam assembly 170 (and/or shaft 152) within the housing 102, manufacturing of the body 172 (or shaft 152), reduction in the amount of material for costs and weight, among other benefits and functions. For instance, in the illustrated embodiment, the body 172 includes a radially extending, annular shoulder 176 defined on the lower end 172a that is configured to engage with a corresponding shoulder (not shown) within the housing 102 (such as a shoulder that is defined on the back panel that is removed from view in FIG. 4 as previously described). During operations, the annular shoulder 176 may be disengaged (and spaced axially away from) from the corresponding shoulder (not shown) within the housing 102 due to the engagement between connectors 178, 32.

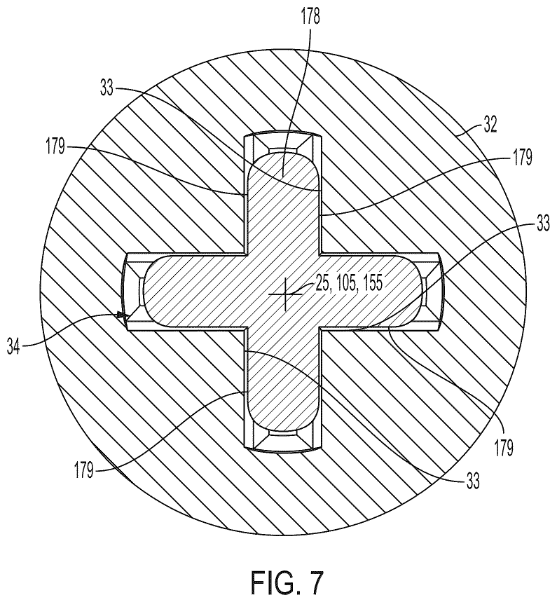

Reference is now made to FIGS. 2, 3, and 5-7, during operations (as previously described), the head assembly 100 may be installed on the handle 20 by inserting the projection 109 into the receptacle 30, to thereby engage the connector 178 within the connector 32. FIG. 6 shows a side cross-sectional view of the powered toothbrush of FIG. 1 detailing the connection between the projection 109 and receptacle 30 according to some embodiments. In addition, FIG. 7 shows a radial cross-sectional of the engaged connectors 178, 32 of the head assembly 100 and handle 20, respectively, taken along section A-A shown in FIG. 6 (with other components removed so as to simplify the drawing).

The connector 32 positioned within the receptacle 30 of handle 20 may be coupled (e.g., directly or indirectly) to the driver 22 (FIG. 1) so that the driver 22 is configured to rotate the receptacle 30 about the longitudinal axis 25 during operations as previously described. When the projection 109 is inserted into the receptacle 30, the connector 178 defined at the lower end portion 152b of the shaft 152 is inserted within the connector 32 so that thereafter, a rotation of the connector 32 about the longitudinal axis 25 may drive a corresponding rotation of the shaft 152 about the axes 105, 155.

The engagement between the connectors 178, 32 may include a keyed connection in which one or more axially extending faceted surfaces on each of the connectors 178, 32 are engaged with one another to transfer torque between the connectors 178, 32 about the aligned axes 25, 105, 155. In particular, as illustrated in FIGS. 5-7, the connector 178 on the shaft 152 is a male connector, and the connector 32 positioned within the receptacle 30 is a female connector that defines a recess 34. Thus, during operations, the male connector 178 on the shaft 152 is received within the recess 34 of the female connector 32 so as to engage one or more (e.g., a plurality of) axially extending facets 179 on the male connector 178 with one or more (e.g., a plurality of) corresponding axially extending facets 33 defined in the recess 34 of the female connector 32. As a result, torque may be transferred from the connector 32 to the shaft 152 via the engagement between the facets 179, 33 of the engaged connectors 178, 32.

The shape of the connectors 178, 32 may be widely varied in different embodiments. For instance, in the illustrated embodiment of FIGS. 5-7, the connector 178 may comprise a Phillips-head shape, similar to that utilized on a Phillips-head screwdriver. Thus, the facets 179 may form a cross shape in the radial cross-sectional view of FIG. 7. Likewise, the recess 34 and the corresponding facets 33 therein may include a complimentary shape that is configured to receive the Phillips-head shaped connector 178 therein. However, other shapes for the connectors 178, 32 contemplated, such as hexagonal (or polygonal more broadly), square, triangular, semi-circular, etc.

It has been surprisingly and unpredictably found that configuration of the connector 178 on the shaft 152 of the head assembly 100 as a male connector, and configuration of the connector 32 within the receptacle 30 of the handle 20 as a female connector for receiving the male connector 178 on shaft 152 substantially reduces the noise and vibrations generated by the powered toothbrush 10 (FIG. 1) during operations. For instance, configuring the connector 178 as a male connector and the connector 32 as a female connector as described may result in a lower measurable noise (e.g., in decibels) from the toothbrush 10, and may result in less vibration (which may be characterized by a smaller vibrational amplitude, lower instantaneous acceleration, and/or other parameters that may be detected with a suitable sensor or camera) within the head assembly 100 during operations.

Without being limited to this or any other theory, it is believed that the reduction in noise and vibration related to the configuration of the connectors 178, 32 as described above is related to the relatively smaller radial span of the male connector 178 about the longitudinal axis 155 of the shaft 152. Specifically, the relatively smaller radial span of the connector 178 reduces the instances of off-balance rotation within the shaft 152 due to a tighter concentration of material about the center of gravity of shaft 152, at the connector 178. Given that much of the excess noise and vibration within a powered toothbrush is caused by off-balance rotation of one or more components, especially within the head assembly 100, the reduction of such off-balance rotation within the head assembly 100 may then in turn substantially reduce the resulting noise and vibration of the head assembly 100 during operations.

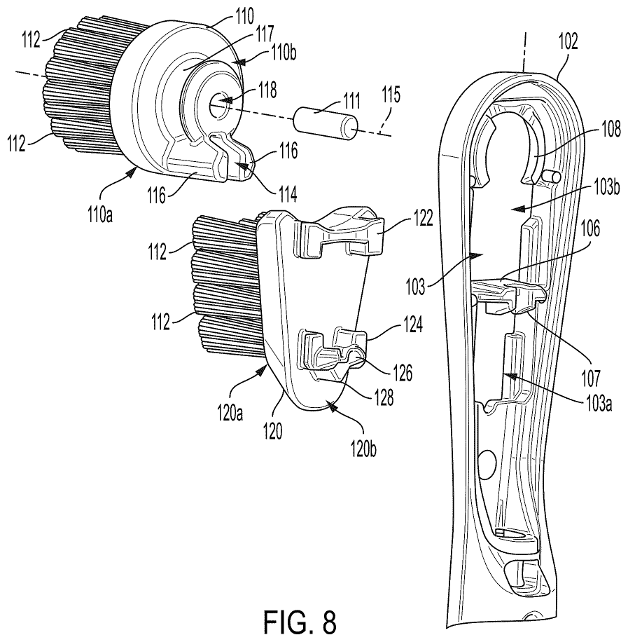

Reference is now made to FIG. 8, the first brush head 110 and the second brush head 120 are shown exploded out from the housing 102 of the head assembly 100 so as to better illustrate the various features of these components. It should be noted that the shaft 152 and biasing member 154 are not illustrated in FIG. 8 so as to simplify the drawing. As illustrated in FIG. 8, the housing 102 includes a front opening 103 that is configured to receive a portion of each of the first brush head 110 and the second brush head 120 therethrough, into the chamber 104 as generally shown in FIG. 4 (note: a back panel of the housing 102 is removed in FIG. 8 so as to better show the chamber 104). The housing 102 includes a cross-piece 106 that extends across the opening 103 so as to separate the opening 103 into a first or lower portion 103a and a second or upper portion 103b. The upper portion 103b may be positioned axially closer (or proximate) to the upper end 100b of the head assembly 100 than the lower portion 103a along the longitudinal axis 105.

The first brush head 110 includes a first or outer side 110a and a second or inner side 110b opposite the outer side 110a. A plurality of bristles 112 extends outward from the outer side 110a so as to engage a user's teeth during operations. The inner side 110b may be at least partially inserted through the upper portion 103b of opening 103 and into the chamber 104 (FIG. 4). In particular, the inner side 110b includes a cylindrical projection 117 that includes bore 118. When the first brush head 110 is inserted through the upper portion 103b of opening 103, the cylindrical projection 117 is inserted through a cylindrical portion 108 formed in the upper portion 103b. The bore 118 receives a pivot shaft 111 therein that may further engage with a surface of the housing 102 (such as a portion of the panel removed from view in FIGS. 4 and 8) to retain the pivot shaft 111 in position during operations. The cylindrical projection 117, bore 118, pivot shaft 111, and cylindrical portion 108 of opening 103 may be aligned with and about the axis of rotation 115 so that during operations, the first brush head 110 may pivot about the axis of rotation 115 via sliding engagement between the cylindrical projection 117 and cylindrical portion 108 of opening and between the bore 118 and pivot shaft 111.

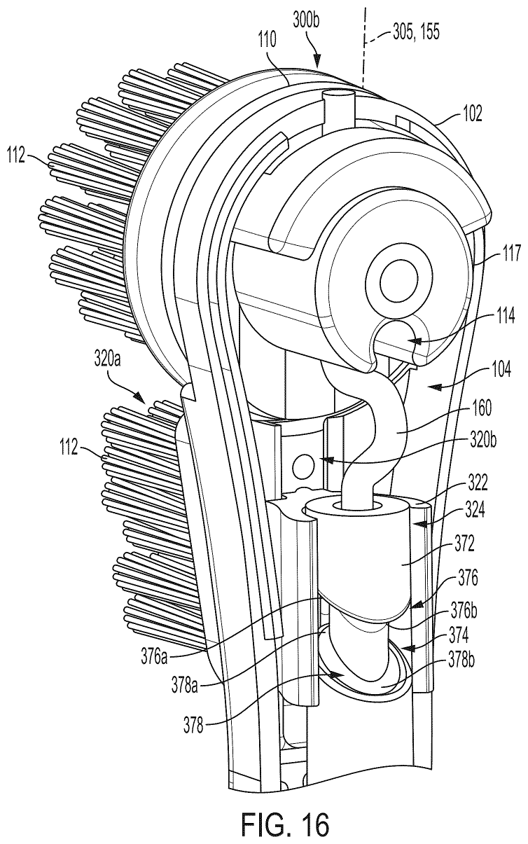

In addition, the inner side 110b of first brush head 110 may also include a slot 114. In the embodiment illustrated in FIG. 8, the slot 114 is defined between a pair of projections 116 extending outward from the inner side 110b. However, in other embodiments, the slot 114 may be defined by other portions of the inner side 110b, such as, for instance, the cylindrical projection 117 (FIG. 16). The slot 114 may be open along a radial side of the first brush head 110 with respect to the axis of rotation 115, such that an object (e.g., the first cam assembly 160 of the shaft 152 as described in more detail below) may be inserted into the slot 114 in a radial direction with respect to axis of rotation 115 during operations.

With continuing reference to FIG. 8, the second brush head 120 also includes a first or outer side 120a and a second or inner side 120b opposite the outer side 120a. A plurality of bristles 112 extends outward from the outer side 120a so as to engage a user's teeth during operations. The inner side 120b may be at least partially inserted through the opening 103 and into the chamber 104 defined by housing 102 during operations (FIG. 4). In particular, the inner side 120b includes a first or upper projection 122 and a second or lower projection 124 spaced from the upper projection 122. The inner side 120b may be at least partially inserted through the opening 103 such that the upper projection 122 is inserted through the upper portion 103b of the opening 103, the lower projection 124 is inserted through the lower portion 103a of the opening 103, and the cross-piece 106 is axially positioned between the upper projection 122 and lower projection 124 along the longitudinal axis 105 of the head assembly 100.

As best shown in FIG. 4, a biasing member 154 (e.g., a coiled spring) may be inserted between the cross-piece 106 and the lower projection 124 on the inner side 120b of the second brush head 120 so as to bias the second brush head 120 axially away from the upper end 100b of the head assembly 100, along the longitudinal axis 105. The axial movement of the second brush head 120 via the bias provided by the biasing member 154 is limited by contact between the upper projection 122 and the cross-piece 106. The lower projection 124 and cross-piece 106 may each a receptacle 126 and 107, respectively, that is configured to receive and retain a corresponding end of the biasing member 154 during operations.

In addition, as is also shown in FIG. 8, the shaft 152 may be inserted within the chamber 104 of housing 102 such that the first cam assembly 160 is at least partially inserted into the slot 114 of the first brush head 110 in a radial direction with respect to the axis of rotation 115, and in an axial direction with respect to the longitudinal axis 155 of shaft 152 (or longitudinal axis 105 of head assembly 100). In addition, a shoulder or projection 128 formed on the lower projection 124 may be engaged with the cam surface 174 defined on the body 172 of second cam assembly 170. Thus, the biasing member 154 may axially bias the lower projection 124 (particularly the shoulder 128) into engagement with the cam surface 174 along the longitudinal axis 105.

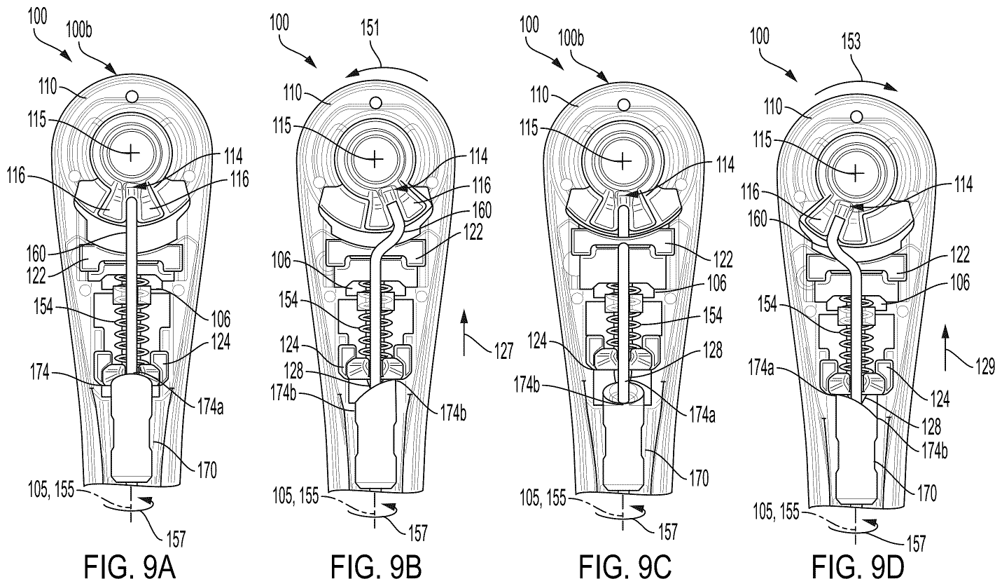

Reference is now made to FIGS. 9A-9D which shows a sequential series of views of the head assembly 100 during a complete of full revolution of the shaft 152 about the longitudinal axis 155 in the circumferential direction 157. First, the rotation of the shaft 152 about the longitudinal axis 155 may cause the first cam assembly 160 to sweep a circumferential arc about the axes 105, 155 within the slot 114, and thereby cause the first brush head 110 to reciprocally pivot about the axis of rotation 115 during operations. Specifically, as shown in the sequence from FIGS. 9A to 9B, rotation of the shaft 152 along a first 180° about the longitudinal axis 155 may cause the first cam assembly 160 to engage against a first of the projections 116 forming the slot 114 to thereby pivot the first brush head 110 in a first circumferential direction 151 about the axis of rotation 115. Conversely, as shown in the sequence from FIG. 9C to 9D, rotation of the shaft 152 along a second 180° about the longitudinal axis 155 may cause the first cam assembly 160 to engage against a second of the projections 116 forming the slot 114 to thereby pivot the first brush head 110 in a second circumferential direction 153 about the axis of rotation 115. The second circumferential direction 153 may be opposite the first circumferential direction 151 about the axis of rotation 115.

In some embodiments, one or both of the slot 114 of the first cam assembly 160 may be at least partially coated or covered in an insulative and/or compliant material so as to reduce noise or vibration associated with the engagement between the first cam assembly 160 and the slot 114 during the above-described operations. In some embodiments, the insulative and/or compliant material at least partially covering the slot 114 or the first cam assembly 160 may comprise a thermoplastic elastomer (TPE).

With continuing reference to FIGS. 9A-9D, as the shaft 152 is rotated about the longitudinal axis 155 within the head assembly 100, the body 172 of the second cam assembly 170 may rotate with the shaft 152 so as to slide the cam surface 174 against the shoulder 128 of the lower projection 124. Specifically, as is illustrated in the sequence from FIGS. 9A to 9B, as the shaft 152 rotates about the first 180° about the longitudinal axis 155, the shoulder 128 is advanced along the cam surface 174 from the second portion 174b toward the first portion 174a so that the second brush head 120 is translated axially toward the upper end 100b along the longitudinal axis 105 (see arrow 127 shown in FIG. 9B). In addition, as is illustrated in the sequence from FIGS. 9C to 9D, as the shaft 152 rotates about the second 180° about the longitudinal axis 155, the shoulder 128 is advanced along the cam surface 174 from the first portion 174a toward the second portion 174b so that the second brush head 120 is translated axially away from the upper end 100b along the longitudinal axis 105 (see arrow 129 in FIG. 9D). Thus, rotating the shaft 152 about the axes 155, 105 may reciprocally translate the second brush head 120 axially along the axes 105, 155 (along the arrows 127, 129).

Thus, the engagement between the first and second cam assemblies 160, 170 and the first and second brush heads 110, 120, respectively, may allow a rotation of the shaft 152 about the longitudinal axis 155 (and thus also the longitudinal axis 105) to drive both a reciprocal pivoting of the first brush head 110 about the axis of rotation 115 and a reciprocal translation of the second brush head 120 along the axes 105, 155. Without being limited to this or any other theory, a rotation of the shaft 152 may produce relatively less noise and vibration than an axial reciprocation of the shaft 152 to drive the motion of the brush heads 110, 120. Specifically, an axial reciprocation of the shaft 152 may subject more (such as substantially all) of the mass of the shaft 152 to translational movement than then when shaft 152 is rotated about the aligned axes 105, 155. This reduction in translated mass may be associated with a reduction in dynamic motion within the head assembly 100 and thereby less noise and vibration during operations. In addition, again without being limited to this or any other theory, the rotation of the shaft 152 (as opposed to an axial reciprocation thereof) may produce relatively less impulse forces in the radial direction and in the axial direction relative to axes 105, 155. Thus, by configuring the transmission assembly 150 to drive the pivoting of the first brush head 110 and the translation of the second brush head 120 via a rotation of the shaft 152, excess noise and vibration generated by operation of the powered toothbrush 10 may be generally reduced for the toothbrush 10 (FIG. 1).

In addition, during the rotation of the shaft 152 and associated actuations of the first brush head 110 and second brush head 120, if the second brush head 120 should become stuck or lodged in the axially upward position (e.g., axially closer to the first brush head 110 and upper end 100b of head assembly 100), the shoulder 128 may simply disengage from the cam surface 174 so that the first brush head 110 may continue pivoting about the axis of rotation 115 unimpeded. Thus, the transmission assembly 150 may allow continued operation of the first brush head 110 in the event that the second brush head 120 becomes stuck in an axially upward position.

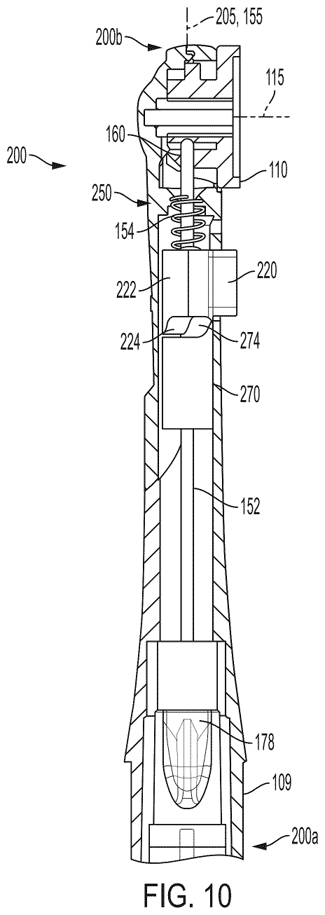

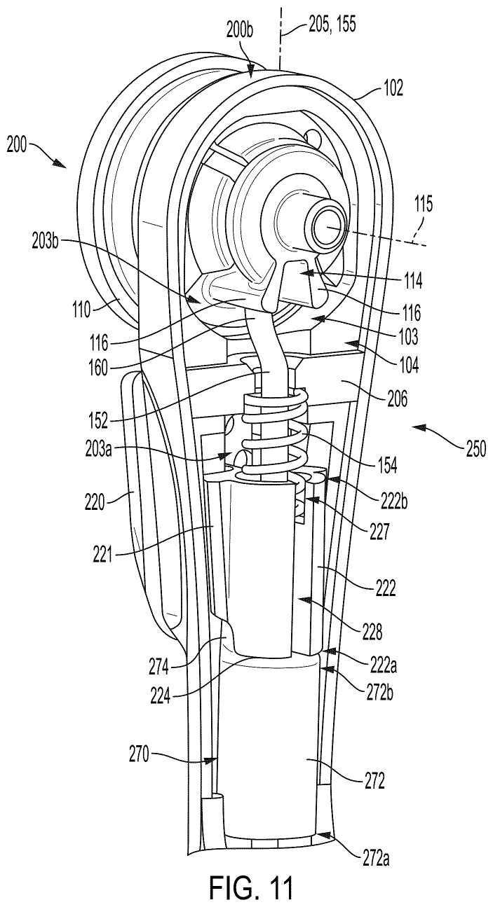

FIGS. 10 and 11 show a head assembly 200 that may be used in place of the head assembly 100 on the powered toothbrush 10 shown in FIG. 1 according to some embodiments. The head assembly 200 includes a longitudinal axis 205, a first or lower end 200a, and a second or upper end 200b that is spaced from the lower end 200a along the longitudinal axis 205. The head assembly 200 may be generally similar to the head assembly 100. Thus, like reference numerals are used herein to indicate features of the head assembly 200 that are shared with the head assembly 100, and the description below will focus on the features of head assembly 200 that are different from the head assembly 100. In particular, the head assembly 200 includes the first brush head 110 as previously described above for the head assembly 100. However, the head assembly 200 also includes a second brush head 220 in place of the second brush head 120 and a transmission assembly 250 in place of the transmission assembly 150. In turn the transmission assembly 250 includes the shaft 152 and first cam assembly 160 for reciprocally pivoting the first brush head 110 about the axis of rotation 115 as previously described as previously described. However, the transmission assembly 250 also includes a second cam assembly 270 in place of the second cam assembly 170 of the transmission assembly 150.

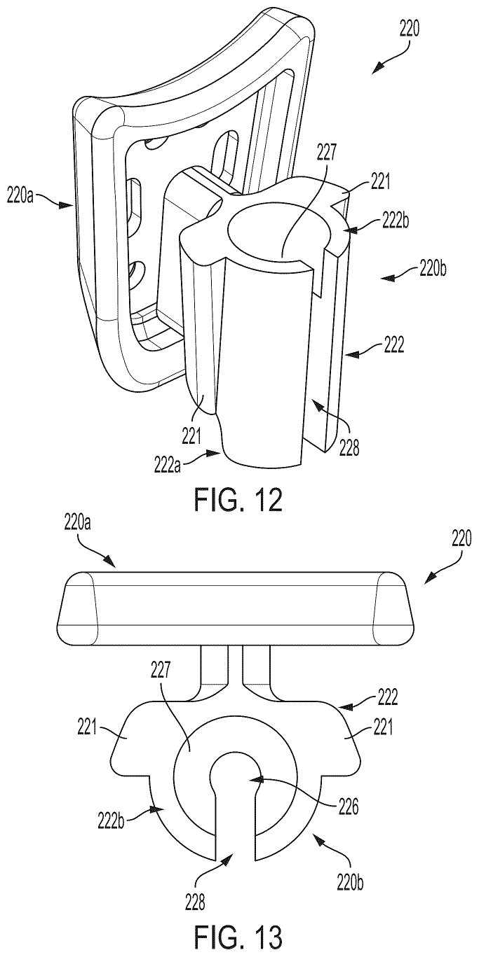

Reference is now made to FIGS. 12 and 13, which show the second brush head 220 of the head assembly 200 according to some embodiments. As previously described above for the second brush head 120, the second brush head 220 includes a first or outer side 220a and a second or inner side 220b opposite the outer side 220a. The outer side 220a includes a plurality of bristles (not shown in FIGS. 12 and 13, but see bristles 112 shown in FIGS. 3, 4, and 8). The inner side 220b includes a collar 222 in place of the projections 122, 124 previously described for the second brush head 120.

The collar 222 includes a first or lower end 222a, a second or upper end 222b, and a throughbore 226 extending between the ends 222a, 222b. A receptacle 227, including an annular shoulder is defined in the throughbore 226 at the upper end 222b. In addition, a longitudinal opening or slit 228 extends into the throughbore 226 from an outer surface of the collar 222 and extends between the ends 222a, 222b. Further, a pair of projections 221 are positioned on an outer surface of the collar 222 that also extend between the ends 222a, 222b.

As shown in FIG. 11, the collar 222 is received through the lower portion 103a of the opening in the housing 102 such that the projections 221 are engaged with an inner surface of the housing 102 to guide axial movement of the second brush head 220 within the housing 102 along the longitudinal axis 105. In addition, the shaft 152 is inserted into the throughbore 226 via the opening 228, and a biasing member 154 is installed about the shaft 152 and is received within the receptacle 227 so as to engaged against the cross-piece 106 as previously described. Thus, the biasing member 154 biases the second brush head 220 axially away from the upper end 200b of the head assembly 200 along the axis 155 of shaft 152.

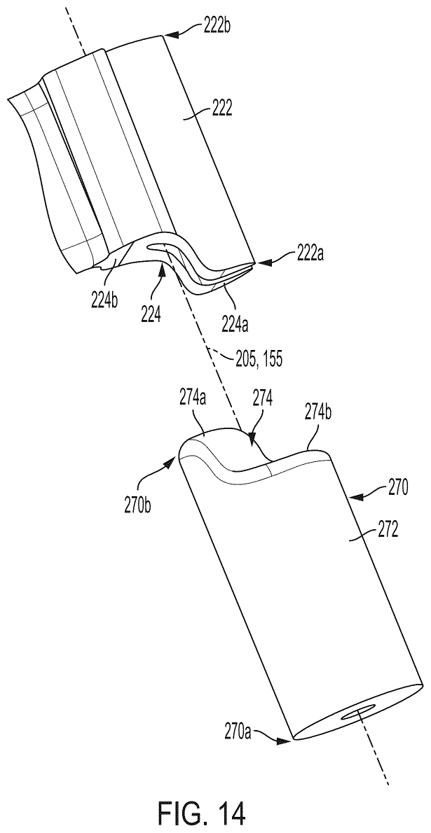

With reference to FIGS. 11 and 14, the second cam assembly 270 includes an annular body 272 that is coupled to the shaft 152 as previously described above for the body 172 of the second cam assembly 170. The body 272 includes a first or lower end 272a and a second or upper end 272b that are spaced from one another along the axis 155 of the shaft 152. The upper end 272b may include or define a cam surface 274. The cam surface 274 may include a first portion 274a and a second portion 274b that are circumferentially spaced from one another about the longitudinal axis 155 of the shaft 152. The first portion 274a may be axially spaced from the second portion 274b so that when the body 272 is coupled to the shaft 152 and installed within the chamber 104 of housing 102 as shown in FIG. 11, the first portion 274a is axially closer to the upper end 200b than the second portion 274b. In addition, in some embodiments, the first portion 274a of the cam surface 174 may at least partially include a spherical or hemispherical curvature, and the second portion 274b may comprise a radially extending planar surface, relative to the longitudinal axis 155 of shaft 152.

As shown in FIG. 11, the cam surface 274 on the upper end 272b of the body 272 may be engaged with the lower end 222a of the collar 222. As shown in FIG. 14, the lower end 222a of the collar 222 may also include or define a cam surface 224 that is complimentary to the cam surface 274 at the upper end 272b of the body 272. In particular, the cam surface 224 of the collar 222 may include a first portion 224a and a second portion 224b that are circumferentially spaced from one another about the longitudinal axis 155 of the shaft 152 (when the shaft 152 is received through the throughbore 226 as previously described). In addition, the first portion 224a may be axially spaced from the second portion 224b along the longitudinal axis 155 (again, when the shaft 152 is received through the throughbore 226 as previously described) such that when the collar 222 is received within the housing 102, the second portion 224b may be positioned axially closer to the upper end 200b than the first portion 224a. The cam surface 224 may also include a smooth, continuous curvature connecting the first portion 224a and the second portion 224b. In addition, one or more portions (e.g., the first portion 224a) of the cam surface 224 may include a spherical or hemispherical curvature as previously described for the cam surface 274.

As may be appreciated from FIGS. 11 and 14, during operations the cam surfaces 274, 224 of the body 272 of second cam assembly 270 and collar 222, respectively, are engaged with one another along the shaft 152. Accordingly, as the shaft 152 is rotated about the axis 155, the body 272 is also rotated about the axis 155 with the shaft 152. The rotation of the body 272 about longitudinal axis 155 slidingly engages the cam surface 274 along the cam surface 224 of the collar 222 so that the first portion 274a of the cam surface 274 is slidingly engaged against the first portion 224a and the second portion 224b of the cam surface 224. When the first portion 274a of cam surface 274 is engaged with the first portion 224a of the cam surface 224, the collar 222 and second brush head 220 may be axially translated toward upper end 200b against the bias provided by biasing member 154, and when the first portion 274a of cam surface 274 is engaged with the second portion 224b of the cam surface 224, the collar 222 and second brush head 220 may be translated axially away from the upper end 200b via the bias provided by biasing member 154. Thus, the rotation of the body 272 of second cam assembly 270 relative to collar 222 may reciprocally, axially translate the second brush head 220 along the axes 105, 155 as previously described above for the second brush head 120 of head assembly 100. The projections 221 may slidingly engage with the housing 102 (about the lower portion 103a of the opening 103) so as to guide the axial translation of the collar 222 and second brush head 220 during operations.

In addition, if the second brush head 220 should become stuck or lodged in the axially upper most position (e.g., axially closer to the first brush head 110 and upper end 200b of head assembly 200) during the rotation of the shaft 152, the cam surfaces 274, 224 may become disengaged so that the first brush head 110 may continue pivoting about the axis of rotation 115 unimpeded. Thus, the transmission assembly 250 may allow continued operation of the first brush head 110 in the event that the second brush head 220 becomes stuck in an axially upward position.

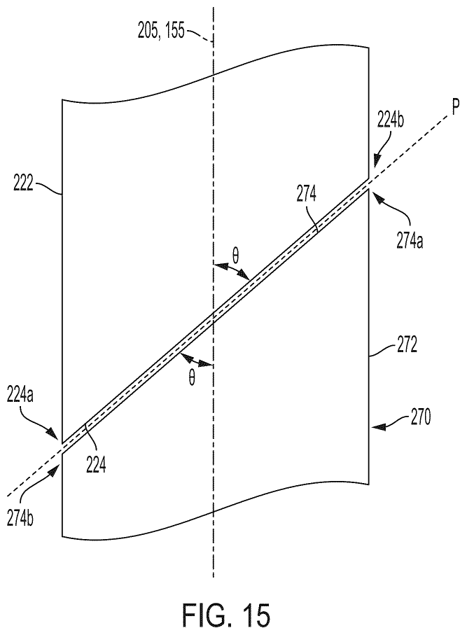

In some embodiments, the complimentary cam surfaces 224, 274 of the collar 222 and body 272 of second cam assembly 270, respectively, may include alternative shapes to those shown in FIGS. 10-14 and described above. For instance, in some embodiments, the cam surfaces 224, 274 may include planar surfaces. FIG. 15 shows an embodiment of the collar 222 and body 272 of second cam assembly 270 in which the cam surfaces 224, 274 both include planar surfaces that lie along a plane P that extends through the longitudinal axes 205, 155 at a non-zero angle θ. The angle θ may be greater than 0° and less than 90° (and thus may be referred to as an acute angle). Thus, the angle θ of the cam surfaces 224, 274 may define the first portions 224a, 274a and the second portions 224b, 274b, respectively, as previously described. During operations, as the body 272 of the second cam assembly 270 is rotated about the longitudinal axis 155 of shaft 152 relative to the collar 222 as previously described, the first portion 274a may be slid along both the first portion 224a and second portion 224b of the cam surface 224 so as to axially translate the collar 222 (and second brush head 220) along the axes 155, 205 as previously described.

FIG. 16 shows a head assembly 300 that may be used in place of the head assembly 100 on the powered toothbrush 10 shown in FIG. 1 according to some embodiments. The head assembly 300 includes a longitudinal axis 305, a first or lower end (not shown), and a second or upper end 300b that is spaced from the lower end along the longitudinal axis 305. The head assembly 300 may be generally similar to the head assembly 100. Thus, like reference numerals are used to indicate features of the head assembly 300 that are shared with the head assembly 100, and the description below will focus on the features of head assembly 300 that are different from the head assembly 100.

Specifically, the head assembly 300 includes the housing 102 and the first brush head 110 of the head assembly 100. However, the head assembly 300 also includes a second brush head 320 in place of the brush head 120. The second brush head 320 includes a first or outer side 320a that includes a plurality of bristles 112, and a second or inner side 320b that is inserted within a chamber 104 of housing 102. The inner side 320b includes a collar 322 that includes an open, longitudinal channel 324.

In addition, the head assembly 300 includes a transmission assembly 350 in place of the transmission assembly 150 of the head assembly 100. In particular, the transmission assembly 350 includes the shaft 152 and the first cam assembly 160 for reciprocally pivoting the first brush head 110 about the axis of rotation 115 as previously described. However, the transmission assembly 350 includes a second cam assembly 370 in place of the second cam assembly 170 of head assembly 100.

The second cam assembly 370 includes a cylindrical body 372 that is coupled to the shaft 152 as previously described above for the body 172 of the second cam assembly 170. The body 372 includes a channel or groove 374 that extends radially into the body 372 from a radially outer surface thereof, and that extends circumferentially or annularly about the axis 155 of the shaft 152 (thus, the channel 374 may be referred to herein as an “annular” channel or groove). Thus, the channel 374 defines or includes a first or upper cam surface 376 and a second or lower cam surface 378 that are axially spaced from one another along the longitudinal axis 155. The axial position of channel 374 varies while extending circumferentially about the longitudinal axis 155, such that the upper cam surface 376 and the lower cam surface 378 each include a first portion 376a, 378a and a second portion 376b, 378b, respectively, that are circumferentially spaced from one another. In addition, the first portions 376a, 378a may be axially spaced from the second portions 376b, 378b, respectively, along the cam surfaces 376, 378, respectively so that when the body 372 is coupled to the shaft 152 and installed within the chamber 104 of housing 102 as shown in FIG. 16, the first portions 376a, 378a of cam surfaces 376, 378, respectively, may be positioned axially closer to the upper end 200b of the head assembly 300 than the second portions 376b, 378b of cam surfaces 376, 378, respectively. The first portions 376a, 378a and the second portions 376b, 378b of the cam surfaces 376, 378 may be circumferentially aligned with one another about the axis 155 of shaft 152.

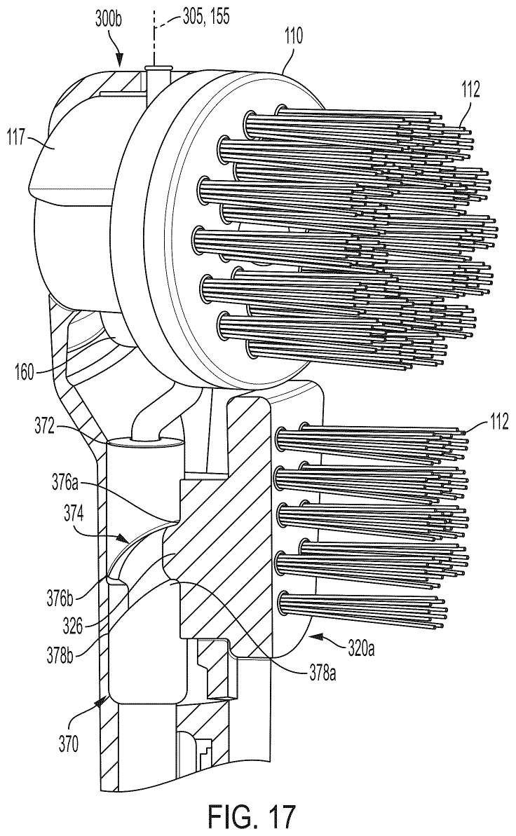

As shown in FIG. 17, a radially extending projection 326 may be formed or defined within the collar 322. During operations, the body 372 may be received within the collar 322 via the open channel 324 so that the projection 326 is inserted within the channel 374. Thereafter, as the body 372 of second cam assembly 370 is rotated about the axis 155 with the shaft 152, the body 372 is rotated within and relative to the collar 322 so that the projection 326 is moved along the channel 374 and slid against the upper cam surface 376 and/or lower cam surface 378. As the first portion 376a and/or the first portion 378a of the cam surfaces 376, 378 are circumferentially aligned with and engaged with the projection 326, the collar 322 and second brush head 320 are translated axially toward the upper end 200b of the head assembly 200 along the longitudinal axes 155, 305, and as the second portion 376b and/r the second portion 378b of the cam surfaces 376, 378 are circumferentially aligned with and engaged with the projection 326, the collar 322 and the second brush head 320 are translated axially away from the upper end 200b of the head assembly 200 along the longitudinal axes 155, 305. Thus, the rotation of the body 372 of second cam assembly 370 relative to collar 322 may reciprocally, axially translate the second brush head 320 along the axes 305, 155 as previously described above for the second brush head 120 of head assembly 100.

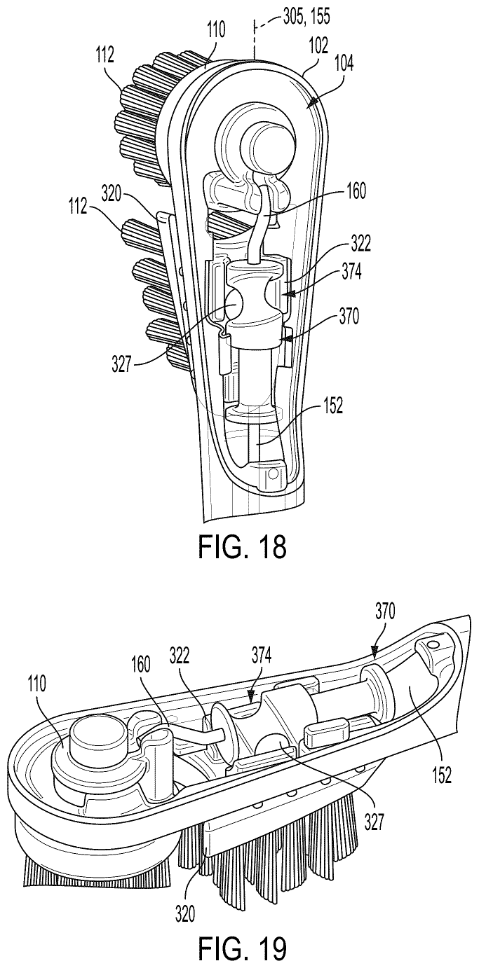

With reference to FIGS. 18 and 19, in some embodiments, the collar 322 of the second brush head 320 shown in FIGS. 15 and 16 may replace the projection 326 with a separate locking member 327 engaged between the collar 322 and the channel 374 of body 372 of second cam assembly 370. The locking member 327 may comprise a sphere or ball that is captured between the channel 324 and collar 322. Without being limited by this or any other theory, utilizing a separate spherical locking member 327 may minimize surface contact with the channel 324 and cam surfaces 376, 378 defined therein so as to reduce friction between the rotating body 372 and second brush head 320 during operations. In addition, the spherical locking member 327 may be constructed of a different material than the rotating body 372 and second brush head 320 so as to further reduce friction. For instance, in some embodiments, the spherical locking member 327 may comprise steel (or another metallic material) while the rotating body 372 and second brush head 320 may comprise a polymer material (e.g., plastic), and the metal-to-polymer interface or engagement may have less friction when compared with other material engagements (e.g., such as plastic-to-plastic engagement). Moreover, constructing the spherical locking member 327 from a metallic material may reduce the wear on the spherical locking member 327 over time, and the spherical shape itself may provide a more uniform shape that may also reduce friction during operations.

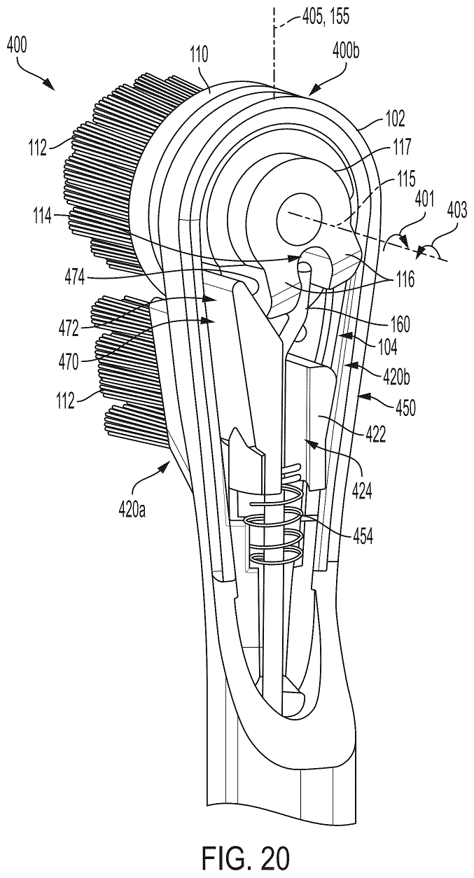

In some embodiments, the second cam assembly may be integrated with the second, translating brush head of the powered toothbrush 10 shown in FIG. 1. For instance, FIG. 20 shows a head assembly 400 that may be used in place of the head assembly 100 on the powered toothbrush 10 shown in FIG. 1 according to some embodiments. The head assembly 400 includes a longitudinal axis 405, a first or lower end (not shown), and a second or upper end 400b that is spaced from the lower end along the longitudinal axis 405. The head assembly 400 may be generally similar to the head assembly 100. Thus, like reference numerals are used to indicate features of the head assembly 400 that are shared with the head assembly 100, and the description below will focus on the features of head assembly 400 that are different from the head assembly 100.

The head assembly 400 includes the housing 102 and the first brush head 110 of the head assembly 100, and also includes a second brush head 420 in place of the brush head 120. The second brush head 420 includes a first or outer side 420a that includes a plurality of bristles 112, and a second or inner side 420b that is inserted within a chamber 104 of housing 102. The inner side 420b includes a collar 422 that includes an open, longitudinal channel 424.

In addition, the head assembly 400 includes a transmission assembly 450 in place of the transmission assembly 150 of the head assembly 100. In particular, the transmission assembly 450 includes the shaft 152 and the first cam assembly 160 for reciprocally pivoting the first brush head 110 about the axis of rotation 115 as previously described. The shaft 152 may extend through the collar 422 of the second brush head 420. In addition, a biasing member 454 (e.g., a coiled spring) may be engaged axially between the collar 422 and a support surface within the chamber 104 so as to bias the collar 422 and second brush head 420 axially toward the upper end 400b along the longitudinal axes 405, 155.

In addition, the transmission assembly 450 includes a second cam assembly 470 that is integrated with the collar 422 of the second brush head 420. In particular, the second cam assembly 470 may include an axial projection 472 that extends axially toward the upper end 400b of head assembly 400 from the collar 422. The axial projection 472 may include a ramped surface 474 that may engage with one of the pair of projections 116 of the first brush head 110. The ramped surface 474 may be a planar surface that lies within a plane that extends at a non-zero angle (e.g., such as an angle between 0° and) 90° relative to the longitudinal axis 155 of the shaft 152.

Thus, as the shaft 152 is rotated about the longitudinal axis 155, the first cam assembly 160 is engaged within the slot 114 to reciprocally pivot the first brush head 110 about the axis of rotation 115 as previously described. As the first brush head 110 pivots about the axis of rotation 115, one of the projections 116 is engaged with the ramped surface 474 so as to exert an axial force on the collar 422 and second brush head 420. In particular, as the first brush head 110 pivots in a first circumferential direction 401 about the axis of rotation 115, one of the projections 166 engages with the ramped surface 474 and slides therealong so as to exert an axial force on the axial projection 472 and collar 422 that moves the second brush head 420 axially away from the upper end 400b against the bias provided by the biasing member 454. Conversely, as the first brush head 110 pivots in a second circumferential direction 403 that is opposite the first circumferential direction 401, the projection 116 may disengage from the ramped surface 474 so that the second brush head 420 may translate axially toward the upper end 400b via the biasing force exerted by biasing member 454. Thus, the rotation of the shaft 152 about the axis 155 may reciprocally pivot (or oscillate) the first brush head 110 in the circumferential directions 401, 402 about the axis of rotation 115 and reciprocally translate the second brush head 420 toward and away from the upper end 400b along the longitudinal axes 405, 155.

The embodiments disclosed herein include powered toothbrushes and brush head assemblies for powered toothbrushes that include direct drive transmission assemblies for driving movement (e.g., such as oscillatory or reciprocal movement) of multiple brush heads on the brush head assembly during operation. In some embodiments, the transmission assemblies described herein may convert a rotational movement of a driver (such as an electric motor) into both a pivoting movement of a first brush head and a translating movement of a second brush head. By using a relatively smoother rotational output from a driver to drive both the pivoting and translating movements of the brush heads, the amount of excess noise and vibrations sensed by the user may be reduced. Accordingly, the embodiments disclosed herein may improve a user's experience when using a powered toothbrush.

The preceding discussion is directed to various exemplary embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment.

The drawing figures are not necessarily to scale. Certain features and components herein may be shown exaggerated in scale or in somewhat schematic form and some details of conventional elements may not be shown in interest of clarity and conciseness.

In the discussion herein and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a given axis (e.g., central axis of a body or a port), while the terms “radial” and “radially” generally mean perpendicular to the given axis. For instance, an axial distance refers to a distance measured along or parallel to the axis, and a radial distance means a distance measured perpendicular to the axis. Further, when used herein (including in the claims), the words “about,” “generally,” “substantially,” “approximately,” and the like, when used in reference to a stated value mean within a range of plus or minus 10% of the stated value.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A brush head assembly for a powered toothbrush, the brush head assembly comprising:
a housing;
a first brush head supported by the housing;
a second brush head supported by the housing; and
a driveshaft positioned in the housing and coupled to the first brush head and the second brush head, the driveshaft having a longitudinal axis, wherein a rotation of the driveshaft about a longitudinal axis is configured to pivot the first brush head and translate the second brush head relative to the housing.

2. The brush head assembly of claim 1, wherein the driveshaft includes a first end portion and a second end portion opposite the first end portion, wherein the second end portion includes a connector that is configured to couple to a driver, and wherein the first end portion includes a first cam assembly that is configured to engage with the first brush head to pivot the first brush head when the driveshaft rotates about the longitudinal axis.

3. The brush head assembly of claim 2, wherein the first cam assembly comprises an eccentric bend in the driveshaft at the first end portion, wherein the first brush head comprises a first side and a second side opposite the first side, wherein a plurality of bristles extends outward from the first side, and wherein the second side includes a slot that is configured to at least partially receive the eccentric bend of the driveshaft therein.

4. The brush head assembly of claim 3, wherein at least one of the slot or the eccentric bend is at least partially coated with a thermoplastic elastomer (TPE).

5. The brush head assembly of claim 2, comprising a second cam assembly that is coupled to the driveshaft such that rotation of the driveshaft about the longitudinal axis is configured to engage the second cam assembly with the second brush head to reciprocally translate the second brush head relative to the housing in an axial direction along the longitudinal axis.

6. The brush head assembly of claim 5, wherein the second cam assembly includes a body having a cam surface that includes a first portion and a second portion,
wherein the first portion is circumferentially spaced from the first portion about the longitudinal axis,
wherein the first portion is axially spaced from the second portion along the longitudinal axis, and
wherein the rotation of the driveshaft about the longitudinal axis is configured to slidingly engage the second brush head along the cam surface to reciprocally translate the second brush head relative to the housing.

7. The brush head assembly of claim 6, wherein the cam surface extends helically about the longitudinal axis.

8. The brush head assembly of claim 6, wherein the first portion of the cam surface comprises a hemispherical curvature.

9. The brush head assembly of claim 6, wherein the cam surface is a planar surface that extends along a plane that extends through longitudinal axis at a non-zero angle.

10. The brush head assembly of claim 6, wherein the cam surface is formed on an axial end of the body.

11. The brush head assembly of claim 6, wherein the cam surface is formed in an annular groove formed in the body that extends radially into a radially outer surface of the body.

12. The brush head assembly of claim 6, wherein the second brush head is biased against the cam surface.

13. The brush head assembly of claim 12, wherein the second brush head is biased against the cam surface with a spring.

14. A powered toothbrush comprising:
a handle including a driver and a female connector coupled to the driver, wherein the female connector includes a recess; and
a brush head assembly coupled to the handle, wherein the brush head assembly comprises:
a housing;
one or more brush heads supported on the housing; and
a driveshaft positioned in the housing, the driveshaft including a longitudinal axis and a male connector, wherein the male connector is inserted within the recess of the female connector such that the driver is configured to rotate the driveshaft about the longitudinal axis via the male connector and the female connector to actuate the one or more brush heads relative to the housing.

15. The powered toothbrush of claim 14, wherein the one or more brush heads comprises a first brush head and a second brush head, and wherein the brush head assembly further comprises:
a first cam assembly that is configured to convert a rotation of the driveshaft about the longitudinal axis into a pivot of the first brush head about an axis of rotation that is orthogonal to the longitudinal axis; and
a second cam assembly that is configured to convert the rotation of the driveshaft about the longitudinal axis into an axial translation of the second brush head along the longitudinal axis.

16. The powered toothbrush of claim 15, wherein the first cam assembly comprises an eccentric bend in the driveshaft.

17. The powered toothbrush of claim 15, wherein the second cam assembly comprises a body coupled to the driveshaft,
wherein the body includes a cam surface that includes a first portion and a second portion,
wherein the first portion is circumferentially spaced from the first portion about the longitudinal axis,
wherein the first portion is axially spaced from the second portion along the longitudinal axis, and
wherein the rotation of the driveshaft about the longitudinal axis is configured to slidingly engage the second brush head along the cam surface to axially translate the second brush head relative to the housing.

18. The powered toothbrush of claim 17, wherein the cam surface is formed on an axial end of the body.

19. The powered toothbrush of claim 17, wherein the cam surface is positioned in an annular groove defined on the body that extends radially into a radially outer surface of the body.

20. The powered toothbrush of claim 17, wherein the second brush head is biased against the cam surface.

21. A brush head assembly for a powered toothbrush, the brush head assembly comprising:
a housing;
a first brush head supported by the housing;
a second brush head supported by the housing; and
a transmission assembly positioned within the housing, the transmission assembly comprising:
a driveshaft having a longitudinal axis;
a first cam assembly configured to convert a rotation of the driveshaft about the longitudinal axis into a pivot of the first brush head about an axis of rotation that is different from the longitudinal axis; and
a second cam assembly configured to convert the rotation of the driveshaft about the longitudinal axis into an axial translation of the second brush head along the longitudinal axis.

22. The brush head assembly of claim 21, wherein the first cam assembly comprises an eccentric bend in the driveshaft that extends radially away from the longitudinal axis, and
wherein the eccentric bend is at least partially inserted within a slot defined on the first brush head.

23. The brush head assembly of claim 22, wherein the second cam assembly comprises a body having a cam surface, and
wherein the rotation of the driveshaft about the longitudinal axis is configured to slide the second brush head along the cam surface.

24. The brush head assembly of claim 23, wherein the driveshaft includes a male connector that is configured to be inserted within a recess of a female connector of a handle of the powered toothbrush.

25. The brush head assembly of claim 24, wherein the male connector comprises a Phillips-head shape.
